(19) United States
(12) Patent Application Publication
(10) Pub. No.: US 2013/0131993 A1
(43) Pub. Date: May 23, 2013

(54) ITERATIVE TIME SERIES MATRIX PATTERN ENHANCER PROCESSOR

(71) Applicant: Lawrence A. Lynn, Westerville, OH (US)

(72) Inventors: Eric N. LYNN, Villa Ridge, MO (US); Lawrence A. LYNN, Columbus, OH (US)

(73) Assignee: Lawrence A. LYNN, Westerville, OH (US)

(21) Appl. No.: 13/677,288

(22) Filed: Nov. 14, 2012

Related U.S. Application Data
(60) Provisional application No. 61/629,164, filed on Nov. 14, 2011.
(60) Provisional application No. 61/629,147, filed on Nov. 14, 2011.

(51) Int. Cl. G06F 19/00

(52) U.S. Cl. CPC G06F 19/34
USPC 702/19

(57) ABSTRACT

A method and system for analyzing data about a physiological occurrence is described herein. The method includes executing a first software element to produce a result set with physiological data related to a set of patients. The method also includes detecting a physiological occurrence within the result set. Furthermore, the method includes generating a second software element to increase the accuracy of the first software element based on the physiological occurrence and the physiological data from the set of patients.

### CROSS-REFERENCE TO RELATED APPLICATIONS

This application claims the benefit of U.S. Provisional Patent Application No. 61/629,164 filed Nov. 14, 2011 and of U.S. Provisional Patent Application No. 61/629,147 filed Nov. 14, 2011, the disclosures of which are hereby incorporated by reference in their entirety for all purposes.

### BACKGROUND

The present techniques provide systems and methods for enhancing and/or identifying an enhanced set of patterns for the identification of clinical conditions and/or diagnosis within a patient population as well as sets of less enhanced patterns that provides a continuum of several statistical metrics with which patient data sets and/or subsets of patient data sets can be characterized.

For purposes of summarizing the disclosure, certain aspects, advantages and novel features of the present techniques have been described herein. It is to be understood that not necessarily all such advantages can be achieved in accordance with any particular embodiment of the techniques disclosed herein. Thus, the techniques disclosed herein can be embodied or carried out in a manner that achieves or enhances one advantage or group of advantages as taught herein without necessarily achieving other advantages as can be taught or suggested herein.

### BRIEF DESCRIPTION OF THE DRAWINGS

Various embodiments will be described hereinafter with reference to the accompanying drawings. These embodiments are illustrated and described by example only, and are not intended to limit the scope of the disclosure. In the drawings, similar elements may have similar reference numerals.

FIG. 1 is a process diagram depicting an overview of one embodiment of the IPE with a flow from left to right; and

FIG. 2 is a Separation Analysis chart depicting an overview of the predictive ability of the Magnitude property of a Rise event within a given Marked Region Universe; and

FIG. 3 is a table representing the “gold-standard” identification of patients within one representative example of the Property Distribution process; and

FIG. 4 is a tabular representation of the results of the representative example of the Property Distribution process in which the results of the execution of scripts are aggregated by property results; and

FIG. 5 is a tabular representation of the results of the representative example of the Property Distribution process in which the aggregated results are sorted by the property value; and

FIG. 6 is a tabular representation of the results of the representative example of the Property Distribution process in which patients identified are shown aggregated by an expanding property range; and

FIG. 7 is a tabular representation of the results of the representative example of the Property Distribution process in which the property range and associated patient counts are displayed; and

FIG. 8 is a tabular representation of the results of the representative example of the Property Distribution process in which patients identified are shown aggregated by an expanding property range; and

FIG. 9 is a tabular representation of the results of the representative example of the Property Distribution process in which scripts are generated and their predictive qualities (as represented by TP, TN, FP and FN are shown; and

FIG. 10 is a graphical representation of the results of the representative example of the Property Distribution process in which ranges are graphed against their predictive qualities within the positive and negative subsets; and

FIG. 11 is a diagram of the sources and results of a Classify Move; and

FIG. 12 is a diagram of the sources and results of a Global Image Move; and

FIG. 13 is a diagram of the feedback cycle of a researcher using an IPE tool; and

FIG. 14 is a block diagram of an example of a computing system that can generate an enhanced result set; and

FIG. 15 is a tangible, non-transitory computer-readable media that can enable a computing system to generate an enhanced result set.

### DETAILED DESCRIPTION OF PRESENT EMBODIMENTS

The relationships of time series patterns described herein may also be detected and identified using time series objectification pattern analysis technologies as discussed in U.S. Pat. No. 7,081,095, U.S. Pat. No. 7,758,503, and U.S. patent application Ser. No. 13/102,307, the entire contents of each of which are incorporated by reference as if completely disclosed herein. The disclosed techniques may be applied to the pattern analysis of these disclosures or to other analysis systems.

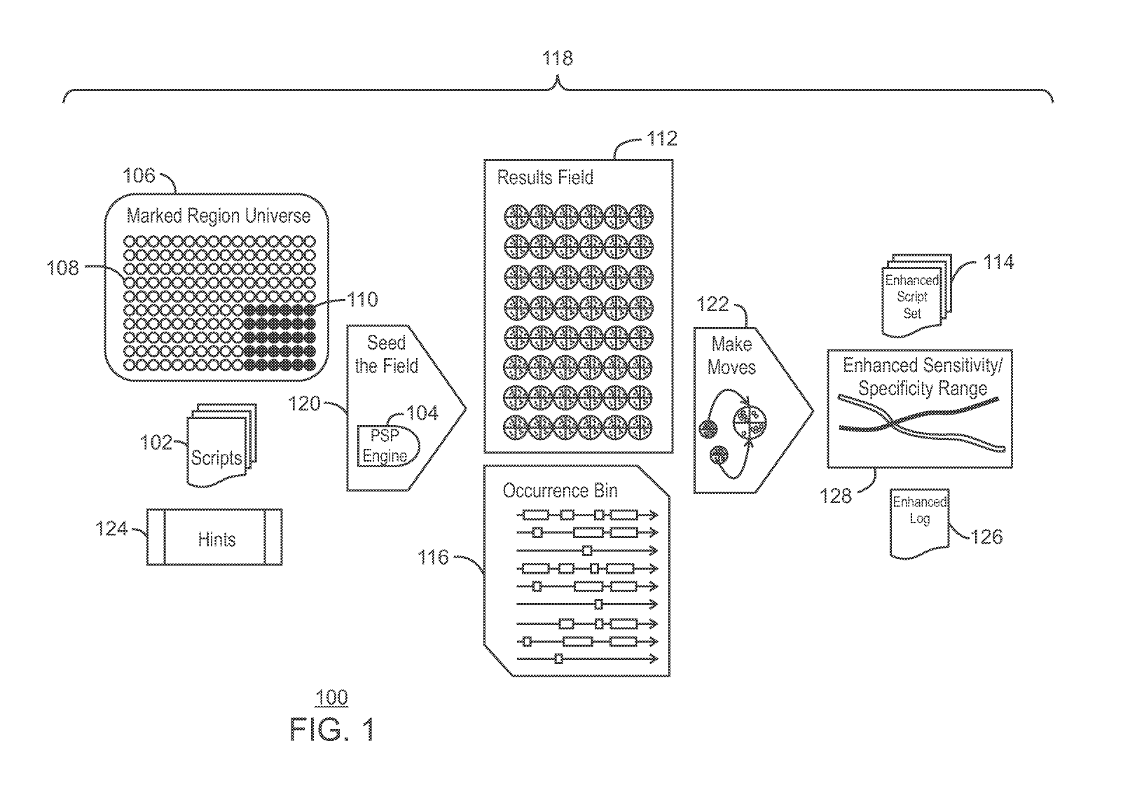

In some embodiments, patterns can be encapsulated within a software element. A software element, as referred to herein, can include computer instructions written using any suitable human-readable computer language. In some examples, the software element can be written as a script using a Domain Specific Language (DSL), such as the Pattern Definition Language (also referred to herein as PDL), among others. In some embodiments, the software elements can be applied to a data region (also referred to herein as a region). In some embodiments, a data region may include a set of time series related to physiological data from a patient within a healthcare facility, and a start time and end time corresponding with the set of time series. PDL scripts (also referred to herein as scripts) 102 of FIG. 1 can be supplied to a software engine called the Patient Safety Processor engine 104 (also referred to herein as PSP engine). In some embodiments, the PDL script 102 can be applied to a data region and the PDL script 102 can identify a number of occurrences (also referred to herein as physiological occurrences), which represents the identification of an instance of a the defined pattern and can be associated with a clinical conditions and/or diagnosis. A PDL script 102 can contain the definitions that correspond with many different occurrences. In some examples, each definition may include various physiological attributes that correspond with a particular occurrence. In some embodiments, a PDL script 102 may attempt to identify a particular occurrence (also referred to herein as a representative occurrence) based on the definition that corresponds with the occurrence. The definition that corresponds with the representative occurrence can be referred to as the anchor occurrence definition for a particular script 102. In one embodiment, each script 102 has one anchor occurrence definition, which may be specified as the last definition within the script 102.

Once a script 102 is executed with data from a particular region, the system can determine whether any occurrences were identified for the anchor occurrence definition. For example, the anchor occurrence definition may include various physiological factors associated with clinical conditions, such as sepsis, among others. If any occurrences are identified based on the anchor occurrence definition, the script 102 is considered to be positive for the given region. If there are not any occurrences identified based on the anchor occurrence definition, the script 102 is considered negative for the given region.

In some embodiments, classifying regions as positive or negative is part of a binary classification test that measures sensitivity and specificity. Sensitivity, as described herein, refers to the proportion of actual positive occurrences for a particular condition which are correctly identified as positive occurrences for a particular condition. For example, sensitivity can measure the percentage of sick people who are correctly identified as having a particular condition. Specificity, as described herein, refers to the proportion of negative occurrences which are correctly identified as negative occurrences. For example, specificity may refer to the percentage of healthy people who are correctly identified as not having a particular condition. This binary classification test provides the ability to match the predictive power of an executed script 102 against a known “gold standard” to determine sensitivity and specificity. A gold standard can refer to a diagnostic test or benchmark that produces the most accurate results provided certain conditions.

In one embodiment, a tag is used to mark a region with a user-defined classification. For example, a tag may be applied to a region to indicate that the region is associated with a “Sepsis” case. In some examples, a “Sepsis” tag is created and applied to all regions which correspond with sepsis cases. In one embodiment, a set of regions is tagged for the enhancement process using any suitable number of tags. In some examples, two tags may be used to tag a set of regions for the enhancement process. A marked region universe 106 may include two tagged regions. One tagged region can indicate the target region universe 108, which may include all of the physiological data points indicated with white and black circles in the marked region universe 106. A second tagged region, the known region set 110, can include a subset of the target region universe 108 and is indicated with the black circles that represent physiological data points in the target region universe 108. The known region set 110 can be tagged to be “known” to have a condition which the scripts 102 are attempting to identify.

In some embodiments, the identification of the target region universe 108 and the known region set 110 can enable the identification of the accuracy of a script 102. For example, a script 102 can be executed and the results of the script 102 can be compared with the target region universe 108 and the known region set 110. In some examples, the script 102 may be configured to identify a particular physiological condition, also referred to herein as a target condition. The comparison of the results of the script 102 with the target region universe 108 and the known region set 110 can determine the sensitivity and specificity of the script 102 in relation to identifying the target condition.

In some embodiments, the sensitivity and specificity can be derived for any suitable number of scripts 102 along with four sets of distinguished regions. In some embodiments, the four sets of distinguished regions can include a true positive set (also referred to herein as a TP set), a true negative set (also referred to herein as a TN set), a false positive set (also referred to herein as a FP set), and a false negative set (also referred to herein as a FN set). A TP set can include regions identified as positive for the target condition by the PDL script 102 and regions marked as positive in the target region universe 108. The TN set can include regions identified as negative for the target condition by the PDL script 102 and regions marked as negative in the target region universe 108. The FP set can include regions identified as positive for the target condition by the PDL script 102, but marked as negative in the target region universe 108. The FN set can include regions identified as negative for the target condition by the PDL script 102, but marked as positive in the target region universe 108.

For each marked region universe 106 to which a specific PDL Script 102 is applied, there may exist a PDL result which combines a reference to the script, the sensitivity and specificity results, and the four sets (TP, TN, FP, FN), which are identified by comparing the script results to the target region universe 108 and the known regions 110. In some examples, the PDL result can be stored in a results field 112. In some embodiments, a PDL result (also referred to herein as a script result) may be acquired without execution of the PSP Engine 104.

Script results can be compared to determine their relative predictive power within the target region universe 108. In some embodiments, the comparison of script results may not be binary. For example, one script result may be more accurate than another script result at predicting various physiological conditions, such as sepsis, among others. In one embodiment, the accuracy of the scripts 102 may be categorized into three groups: a high accuracy group, a low accuracy group, and an inconclusive group. A high accuracy group may indicate a higher sensitivity and specificity than a low accuracy group. A low accuracy group may indicate that neither sensitivity nor specificity is higher than the high accuracy group. All other comparisons can be categorized as inconclusive. In an alternative embodiment, time is also considered such that the comparison would also take into consideration the earliest possible time at which the specified pattern could be identified within the region.

In the current embodiment, the inconclusive nature of script result comparison causes the result of the enhancement process to be a set of scripts rather than a single script and therefore the result of the iterative enhancement process includes an enhanced script set 114. An enhanced script set 114 can refer to an aggregation of script instances that represent the results from an enhancement. In some examples, an enhanced script set 114 may exclude scripts 102 that provide a lower accuracy result. In some embodiments, a line graph may be created (as shown in FIG. 1), in which the left axis represents a percentage and the bottom axis represents various script instances that are aligned from the least sensitivity to greatest sensitivity. In some examples, the overall predictive value can be presented as two lines representing sensitivity and specificity. In some embodiments, a single script may be found that produces 100% sensitivity and 100% specificity. In some examples, a single script that produces 100% sensitivity and 100% specificity may represent the enhanced script set.

PDL scripts 102 may be composable, that is to say that a PDL script 102 can be composed of two or more different PDL scripts 102. In some embodiments, PDL scripts 102 can be combined in various ways. For example, two PDL Scripts 102 that describe events as their anchor occurrence definition can be combined to form a script with a binary as its anchor occurrence definition. In some examples, the script result generated from the composition of other scripts 102 can be different from the script results of the individual scripts 102 which make up the composition. Further, the script result of the composition of two individual scripts 102 may provide better predictive value than any individual script.

In the current embodiment, the process of combining two scripts 102 into a single script 102 is called a script consolidation move (also referred to as a move). In an alternative embodiment, moves can create a new script using techniques other than the combination of individual scripts 102. In some examples, a move can create a new script by modifying an existing script. For example, a move can create a new script by altering the where clause and/or event correction criteria contained in an existing script. A move creates a new script and a new script result. Moves can be characterized by their comparative effect on the script result. In some embodiments, a safe move is characterized as a move that does not add any results to either the false positive set or the false negative sets within the script result (as compared to the scripts 102 used by the move to generate a final script). In some examples, safe moves are considered valuable because they do not decrease either the sensitivity or the specificity of the result. If a Safe Move adds either to the number of True Positives or the True Negatives, then the Safe Move increases Sensitivity and/or Specificity without any “cost” (i.e. without decreasing either Sensitivity and/or Specificity).

Since the outcome of a move can be a valid PDL script 102, the result of a move can be determined by executing the resultant script through the PSP Engine 104. In some cases, the outcome of a move can be derived without executing the PSP Engine 104. For example, if all of the occurrence instances are available as represented by an occurrence thumbnail (a lightweight object which contains a representation of an occurrence instance and the type of the occurrence instance, region association, start time, and end time, among others), an examination of these occurrence thumbnail can determine the script results of a binary move if the move does not include a “where clause.”

In one embodiment, moves may be split into three groups: a deterministic move, a relational move, and an experimental move. A deterministic move can be a move in which the result can be derived by looking at the respective script results of the scripts which can make up the final composition. A relational move is a move for which the result can be derived by looking at a comprehensive set of occurrence thumbnails (also referred to herein as the occurrence bin) 116 of FIG. 1 to determine instance relationships as determined by coincidence within time. In some embodiments, experimental moves can be implemented through either the execution of the PSP Engine 104 or an alternative search against a comprehensive set of occurrences for any suitable number of scripts for any suitable number of regions within the Universal Region Universe.

In some embodiments, deterministic moves, relational moves, and experimental moves can indicate a “computational cost.” For example, the computational cost may include factors such as execution time, processing power, and memory usage. In some embodiments, an experimental move can be more computationally expensive than a relational move. Additionally, a relational move can be more computationally expensive than a deterministic move.

In one embodiment, the iterative pattern enhancement engine (also referred to herein as IPE engine) 118 can be broken down into two phases as shown in FIG. 1. The first phase (labeled “Seed the Field”) 120 includes compiling a field of script results with known predictive characteristics (e.g. sensitivity and specificity as well as the TP set, FP set, TN set, and FN set, among others) against a target region universe 108 to produce a results field 112. This process, described below in detail, generates or otherwise obtains a set of scripts that will be the source of moves identified in the second phase. For example, a set of streams may be input from which a simple event scripts (single stream events such as rise or fall or threshold events) can be derived. Or more complex scripts can be generated or provided from the researcher directly. The second phase (also referred to herein as make moves) 122 can include identifying and executing combinatorial moves against the field to gain new scripts that have desirable predictive characteristics. In one embodiment, this process is facilitated by the compatibility of the definition mechanism of PDL. For example, simple event scripts can be randomly combined into binaries to investigate the predictive power of their aggregation. As described below, the present embodiment employs a more directed approach to more efficiently accomplish the goals of enhancement. The “make moves” phase encapsulates any or all algorithms for altering, combining or deriving scripts which may demonstrate enhanced predictive properties as defined by the goals of the IPE session.

In some examples, desirable predictive characteristics may be designated as better sensitivity and/or specificity. Alternatively, better predictive characteristics may be designated as “filling the gaps” within the overall continuum of predictability. For example, the IPE engine 118 may include generating a broad distribution of scripts 102 that have a very high granularity of predictive behavior. In some examples, the IPE engine 118 may generate scripts 102 that have a broad distribution of specificity. For example, if scripts 102 are identified that have specificity below 70% and specificity above 80%, the IPE engine 118 may identify scripts 102 that have specificity between 70 and 80%. In these examples, the IPE engine 118 can fill in the gaps within a predictive continuum in addition to finding “better” predictive results.

In some embodiments, scripts 102 can be based on physiological streams. For example, one script may be based on White Blood Count (also referred to herein as WBC). Another script may be based on Platelets and Bicarbonate. In one embodiment, every script has a finite set of at least one physiological stream on which the script is based. The set of physiological streams on which a script is based is called the dependent point stream set. In some embodiments, the IPE engine 118 may use a broad range of dependent point stream sets. For example, an IPE engine 118 may identify a script that is highly sensitive and specific to sepsis, along with additional scripts 102 that are highly sensitive and specific to sepsis but are based on different dependent point stream sets. In these examples, the IPE engine 118 can identify a correlation between patients that have sepsis using various different scripts 102. In some embodiments, the IPE engine 118 may not have access to several physiological streams. In these embodiments, access to a wide range of scripts 102 can increase the robustness of the overall system.

In one embodiment, seeding the field 120 is the first phase of the IPE engine 118. Seeding the field 120 can refer to generating a set of results 110 (also referred to herein as a result set) for a script 102 based on the target region universe 108. In some embodiments, seeding the field 120 within the IPE engine 118 may be automated by a processor or adaptively applied.

In some embodiments, the process of seeding the field 120 can use a target region universe 108 that includes a marked region 108. In some examples, the target region universe 108 can include an indication as to which data regions within the target region universe 108 have a condition (e.g. sepsis, among others) and which data regions do not have a condition. This marked set is referred to as the marked region universe 106. Alternatively, the process of seeding the field 120 can use multiple marked region universes 106.

In some embodiments, additional input can be supplied. For example, the process of seeding the field can also include scripts 102 and hints 124. In one embodiment, the scripts 102 can include set of predetermined PDL scripts 102. In some examples, the predetermined PDL scripts 102 may be translated from scripts 102 written with another tool or in a simple text editor. In some embodiments, the scripts 102 may comply with the PDL language format and the scripts 102 may be expected to execute without error. In some examples, invalid scripts 102 can be identified and/or ignored without stopping the seeding the field 120 process.

In one embodiment, scripts 102 are executed through the PSP engine 104 and matched against the marked region universe 106 to generate predictive characteristics such as sensitivity, specificity, a true positive set, a true negative set, a false positive set, and a false negative set, among others. Once predictive characteristics have been generated, a result object is created and put into the results field 112. In some embodiments, the IPE engine 118 may decompose the scripts 102 and seed the field 120 with individual elements of the script 102.

For example, the script 102 may contain the following language:

identify platelet_fall as fall in Platelets
where { ( candidate.Magnitude / candidate.FirstValue ) >= 0.2} ;
identify bicarb_fall as fall in Bicarbonate
where { ( candidate.Magnitude / candidate.FirstValue ) >= 0.2} ;
identify destabilization as platelet_fall following bicarb_fall within 1d;

In this example, the script 102 may indicate for the IPE engine 118 to generate 3 separate scripts 102: one script for platelet_fall, one script for bicarb_fall, and one script for destabilization. In some embodiments, the IPE engine 118 can analyze the accuracy of each of the three scripts 102 separately. In some examples, each script may produce different results, which can affect the size of the results field 112. In one embodiment, portions of a script 102 may not produce results that are included in the results field 112. For example, portions of a script 102, such as a portion related to platelet_fall, among others, may not produce results if the portion of the script 102 failed to execute properly. In some examples, the results from a portion of a script 102 may be excluded from the results field 112 if the results do not meet other criteria. In some embodiments, portions of a script 102 that do execute and meet certain criteria may have results included in the results field 112.

In some embodiments, the IPE engine process 114 can proceed with a script 102 if the script 102 produces more than 1 result. In some examples, the IPE engine process 114 can proceed without seeding the field 120 with any additional scripts 102.

In one embodiment, the IPE engine 118 can provide one or more mechanisms to seed the field 120. In some examples, scripts 102 can be generated to seed the field 120 using a variety of automated techniques. In one embodiment, the IPE engine 118 can generate scripts 102 by starting with a script template and generating a set of scripts from the script template. For example, a script template may include the following language:

“identify @Name as {value<@X} in WBC;”

In this example, the script template can indicate a threshold event within the PSP engine 104. In some embodiments, the script template may or may not be a valid PDL script, but the script template is preferably in the shape of a valid PDL Script. In some embodiments, the script template is a PDL Script with elements set as variables. If the variables are replaced with valid script elements, then a valid PDL script can be produced. In the above example, the script template contains two variables: @Name and @X. In some examples, the two variables can be set to particular values. For example, the two variables may be set with the statements @Name=“WBC_Below2” and @X=2. In some embodiments, setting the variables can result in a new script. In the example above, a new script may be generated with the following language:

identify WBC_Below2 as {value<2} in WBC;

In some embodiments, a template along with a set of variable values can represent a set of scripts. For example, the following template and variables can produce three scripts:

identify @Name as { value < @X } in WBC;
“WBC_Below2” 2
“WBC_Below3” 3
“WBC_Below4” 4

The IPE engine 118 can use the scripts 102 produced from templates and variables to provide results for the seed the field process 116. Once an executable script has been generated, the executable script can be analyzed through the PSP engine 104 and placed, along with the predictive characteristics for the executable script, into the results field 112.

In some embodiments, the IPE engine 118 can generate any suitable number of scripts 102 provided a template and a range of variable values. In some examples, if a WBC variable is considered to have a particular range, then the IPE engine 118 can determine the number of scripts 102 to create. For example, if the WBC variable has a range between 0 and 30, the IPE engine 118 may generate a set of 10 scripts 102 using the following WBC variable values:

| | |
|---|---|
| “WBC_Below3” | 3 |
| “WBC_Below6” | 6 |
| “WBC_Below9” | 9 |
| “WBC_Below12” | 12 |
| “WBC_Below15” | 15 |
| “WBC_Below18” | 18 |
| “WBC_Below21” | 21 |
| “WBC_Below24” | 24 |
| “WBC_Below27” | 27 |
| “WBC_Below30” | 30 |

In some embodiments, the IPE engine 118 may detect results from any suitable number of scripts 102 generated by the IPE engine 118. For example, ten scripts 102 may produce ten results, which can be placed in the results field 112. In some examples, the IPE engine 118 can repeat the process of generating scripts 102 and placing results from the scripts 102 in the results field 112 for any number of physiological streams.

In some embodiments, the IPE engine 118 automates the creation of scripts 102 in the seed the field 120 phase and generates higher level objects such as binaries, images, classifications, and repeating occurrences, among others, in the subsequent phase referred to as make moves 122. In some examples, the final input into the seeding the field process 116 is the hints 124. The hints 124 inform, constrain and/or direct both the seeding the field process 116 and the make moves 122 process. For example, the hints 124 may contain any suitable number of elements that can be analyzed within the seeding the field process 116. In some examples, the hints 124 may include elements that indicate physiological streams from which scripts 102 should be constructed. The hints 124 may also include specific event correction script elements used to create templates and parameters by which templates can be constructed. Additionally, the hints 124 may include parameters to constrain and/or direct the choice of variable values within particular ranges that are used with templates to generate any suitable number of scripts 102. In some embodiments, the hints 124 represent configuration entries and values and can be detected through a tool, such as a graphical user interface or through an automated process. In one embodiment, this configuration can be persisted, transmitted and retrieved.

Seeding the Field with Property Distribution Analysis

In some embodiments, script generation can use data regions in the target region universe 108 as a source for variable values in script templates. In some examples, the scripts 102 that are generated based on the variable values and the script templates can produce results that are included in the results field 112. For example, instead of choosing arbitrary ranges for variable values for a script template, the IPE engine 118 can analyze the target region universe 108 to determine variable values that provide predictive separation within a particular target region universe 108.

In some examples, the variable values may be selected for a template, such as “identify @Name as {value<@X} in WBC,” by taking a range of variable values of WBC and dividing the range of variable values into equal windows. In some embodiments, selecting variable values by dividing a range of variable values into equal windows can be used by the IPE engine 118. In some examples, if the target region universe 108 includes patients that have been marked as having a particular condition, such as sepsis, then data from the target region universe 108 can be used to guide the selection of values for the variables. For example, determining variable values by equally splitting a range of variable values can provide a high predictive granularity with the least number of scripts 102.

In some embodiments, the IPE engine 118 can use a process called property distribution analysis to determine the appropriate number of variable values to select from a range of variable values. In some examples, the property distribution analysis process can determine the number of variable values to select for any number of physiological factors, such as WBC, among others. The property distribution analysis process can prevent the selection of too few variable values from a range of variable values, which can obscure predictive characteristics. The property distribution analysis process can also prevent the selection of too many variable values from a range of variable values, which can result in the generation of too many scripts 102 with the same predictive characteristics. If the property distribution analysis process generates too many scripts 102, the IPE engine process 114 can become inefficient and the results may be overly complicated. The property distribution analysis process of the IPE engine 118 can identify various numbers of variable values to select based on the data, which can ensure the generation of scripts 102 with different predictive characteristics.

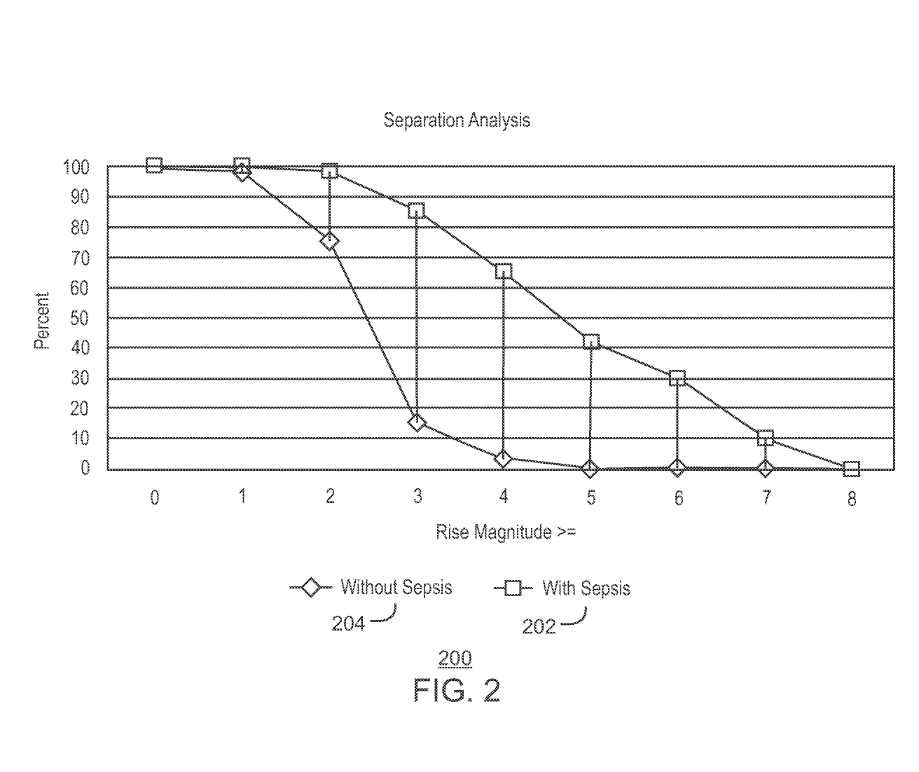

In one embodiment, the process of property distribution analysis is based on the process of using a sliding property value to find statistical separation. FIG. 2 provides an example graphical representation of the process of using a sliding property value to find statistical separation. In some embodiments, statistical separation can refer to the difference in the percentage of patients who suffer from a condition and the percentage of patients who do not suffer from a condition, but exhibit the same physiological factors. For example, a rise in WBC may be a predictor of sepsis. In some examples, a chart 200 can be generated to depict the magnitude of the rise in WBC. The chart 200 shows a plot for both sepsis matches and non-sepsis matches. In some embodiments, the sepsis matches 202 and non-sepsis matches 204 are identified using the following script referred to herein as Script 1:

identify RiseInWBC as rise in WBC where {Candidate.Magnitude>@X}

In Script 1, candidate.magnitude indicates the magnitude for particular candidate values. In some examples, magnitude can refer to an increase in a physiological measurement in relation to time. Additionally, @X indicates the variable X has a particular value, such as a positive integer, among others. In some examples, the following script, referred to herein as Script 2, is generated when the value of X equals 0:

identify RiseInWBC as Rise in WBC where {Candidate.Magnitude>0}

In some examples, Script 2 may identify at least one occurrence of a rise in WBC in 100% of the sepsis cases and also at least one occurrence of a rise in WBC in 100% of the Non-Sepsis cases. In these examples, every patient within the target region universe 108 had some rise in WBC during a hospital stay. Therefore, Script 2 may provide very little statistical separation between sepsis and non-sepsis patients because the rise in magnitude in Script 2 is equal to zero. As the magnitude increases in the chart 200, the chart depicts some degree of statistical separation. For example, when the magnitude equals 1, a higher percentage of sepsis patients than non-sepsis patients are identified. In another example, when the magnitude equals 2, the statistical separation between sepsis patients and the non-sepsis patients becomes greater. According to chart 200, when the magnitude of the rise in WBC is 2 or greater, 98% of Sepsis patients have a WBC rise of this magnitude, while 75% of non-sepsis patients have a rise in WBC of this magnitude. According to chart 200, a Magnitude>=3 corresponds with a larger statistical separation in patients that have a rise in WBC. In one example, 85% of sepsis patients have a rise in WBC of at least a magnitude 3, while 15% of non-sepsis patients have a rise in WBC of at least a magnitude 3. In some embodiments, as the size of the magnitude of the rise in WBC increases, regions of statistical separation exist. In one embodiment, the process of analyzing the increase in magnitude of the rise in WBC is modeled with the Property Distribution Analysis in the IPE.

It should be noted that FIG. 2 represents one example of statistical separation based on a sliding property. In other examples, the statistical separation based on a sliding property may difficult to identify because various factors can complicate the statistical separation analysis. In some embodiments, statistical separation analysis is one of many techniques that the IPE engine 118 can use to generate a wide range of scripts. In some examples, the scripts can be used by moves to reflect larger relational patterns that can more accurately and comprehensively describe patterns associated with evolving patterns of disease progression.

In one embodiment, the IPE engine 118 simulates the process of identifying statistical separation by using a sliding property value illustrated in FIG. 2. The simulation process, referred to herein as property distribution analysis, begins with a template. For example, the following template script, referred to herein as Script 3, is a directional event template which identifies trends in a platelet stream (See the aforementioned U.S. patent application Ser. Nos. 12/437,285 and 12/437,417):

identify @Name as fall in Platelets rogued { trend2.Magnitude < 15 }
plateau as trend recalibrate min to first max to last
Where {Candidate.PercentChange >= @X};

In this example, Script 3 contains two variables: @Name and @X. In some embodiments, the IPE engine 118 may have several functions that can generate unique names. In these embodiments, the IPE engine 118 may attempt to identify the variable @X. In the above example, the template can represent a property distribution analysis regarding the PercentChange property.

The use of the operator “>=” provides the process with a sliding characteristic such that the scripts may range from identifying a majority of the patients in the target region universe 108 with a condition, to identifying fewer patients with a condition. The sliding characteristic is depicted in relation to the statistical separation analysis of chart 200 of FIG. 2.

In some embodiments, the property distribution analysis process uses a template script, a property variable, and an operator. In some examples, the distribution analysis process includes creating a broadly defined script to obtain a superset of occurrences from which properties can be analyzed. For example, the property distribution analysis process may use the following script, also referred to herein as Script 4:

identify x as fall in Platelets rogued { trend2.Magnitude < 15 };
plateau as trend recalibrate min to first max to last;

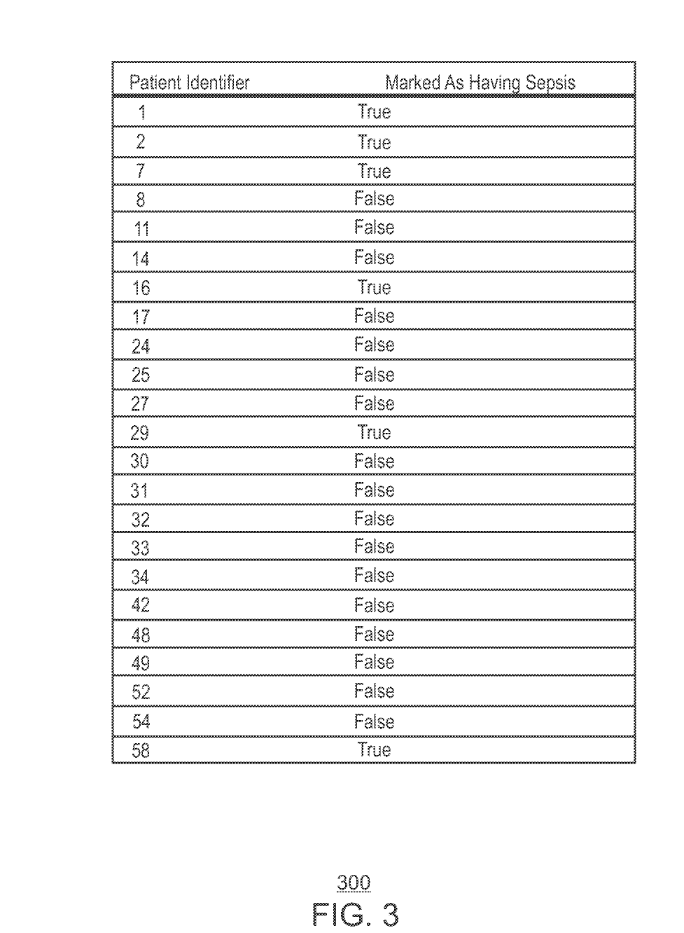

In some examples, Script 4 may be an executable PDL script derived from the template script. In this example, Script 4 may use template Script 3, but can remove the filter “Where {Candidate.PercentChange>=@X}” such that all fall occurrences are identified. FIG. 3 shows an example list of patients with the patients' respective sepsis designation. In table 300, a set of 23 patients is identified. Within the set of 23 patients that are identified, 6 of the patients have been identified as having sepsis.

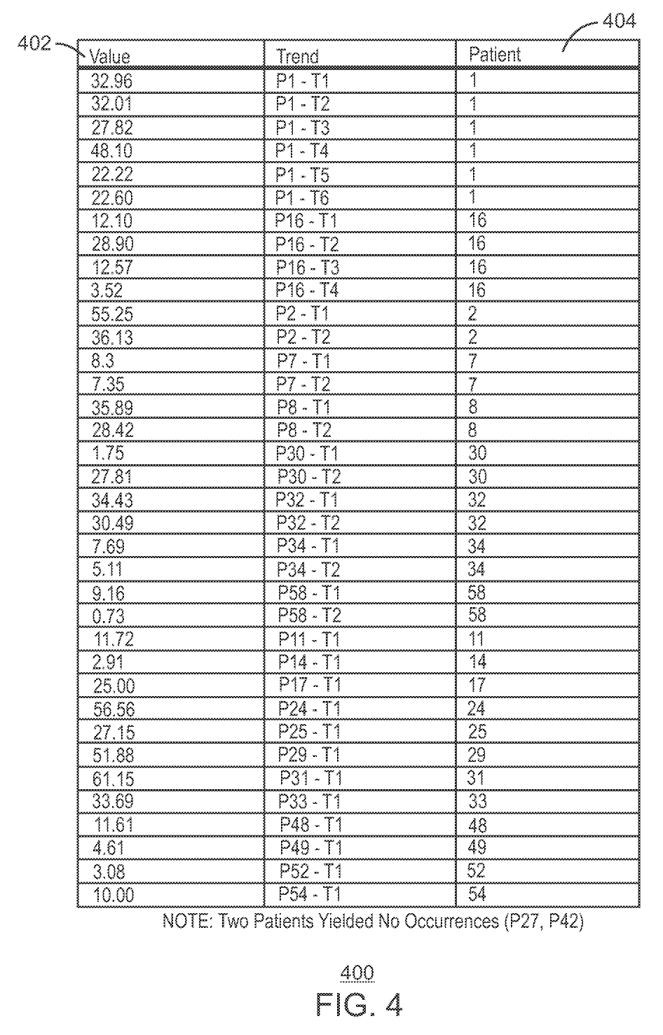

In one embodiment, the property distribution analysis process also includes executing Script 4 with data from the 23 patients and aggregating the results into a table 400 of FIG. 4. In some embodiments, table 400 can isolate the PercentChange property and associate a percent change value 402 with the patient 404 in which the percent change value was found. FIG. 4 shows the result of the process of executing Script 4 with data from 23 patients 404 and aggregating the results into table 400. In some examples, patients such as two of the patients from table 400 (patients 27 and 42) may not have any occurrences.

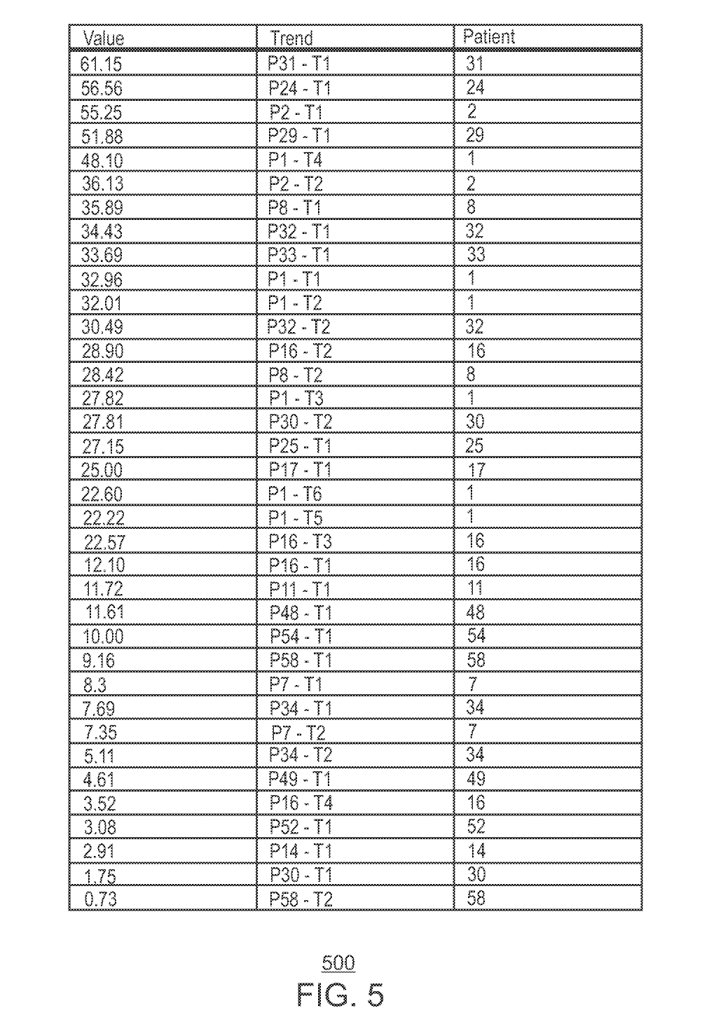

In one embodiment, the property distribution analysis process also includes sorting the results by the property value. In some examples, the property distribution analysis process may focus on results that are greater or equal to a particular magnitude. In these examples, the results may be sorted in table 500 of FIG. 5 in descending order in order to isolate the specificity at the extreme. The results of sorting the results by the property value are shown in FIG. 5.

In some embodiments, the property distribution analysis process may also include grouping the results in order to verify that duplicate values do not exist. As seen in FIG. 4, there are not any duplicate values present in the chart 400 or chart 500.

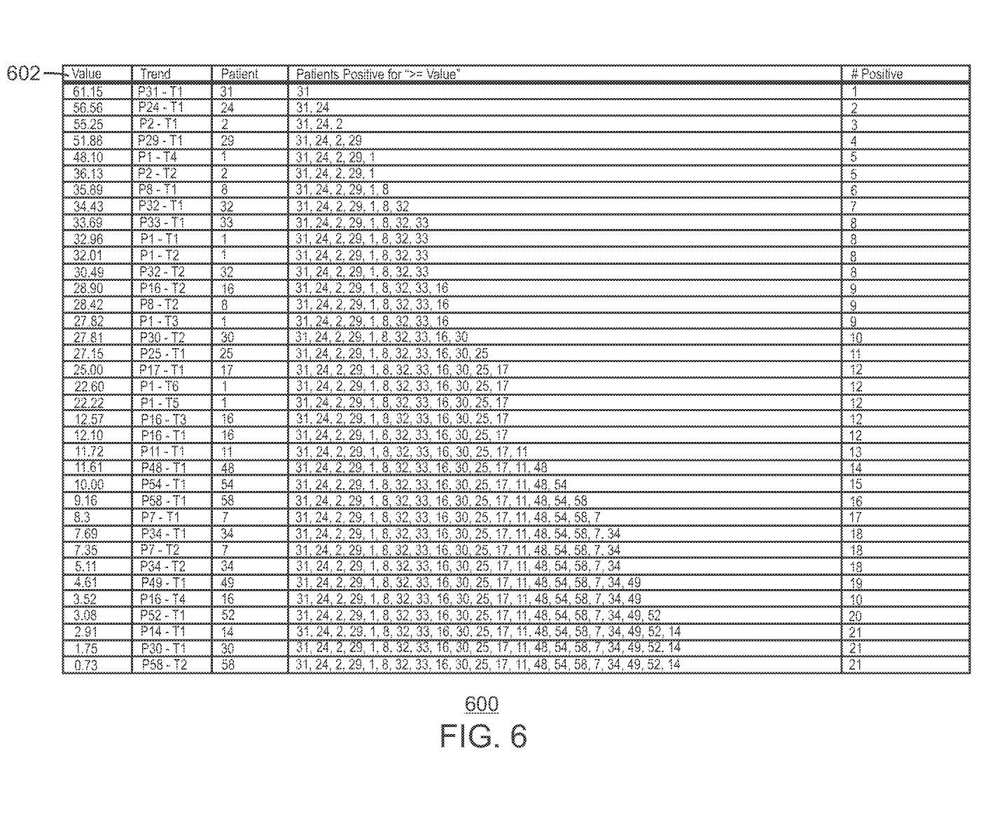

FIG. 6 depicts a table that includes aggregated patient data. In some embodiments, the property distribution analysis process includes generating a table 600 by aggregating the patients for any suitable number of rows. In some examples, each row can include the patients that have a variable value 602 for a condition determined by “>=@X.”

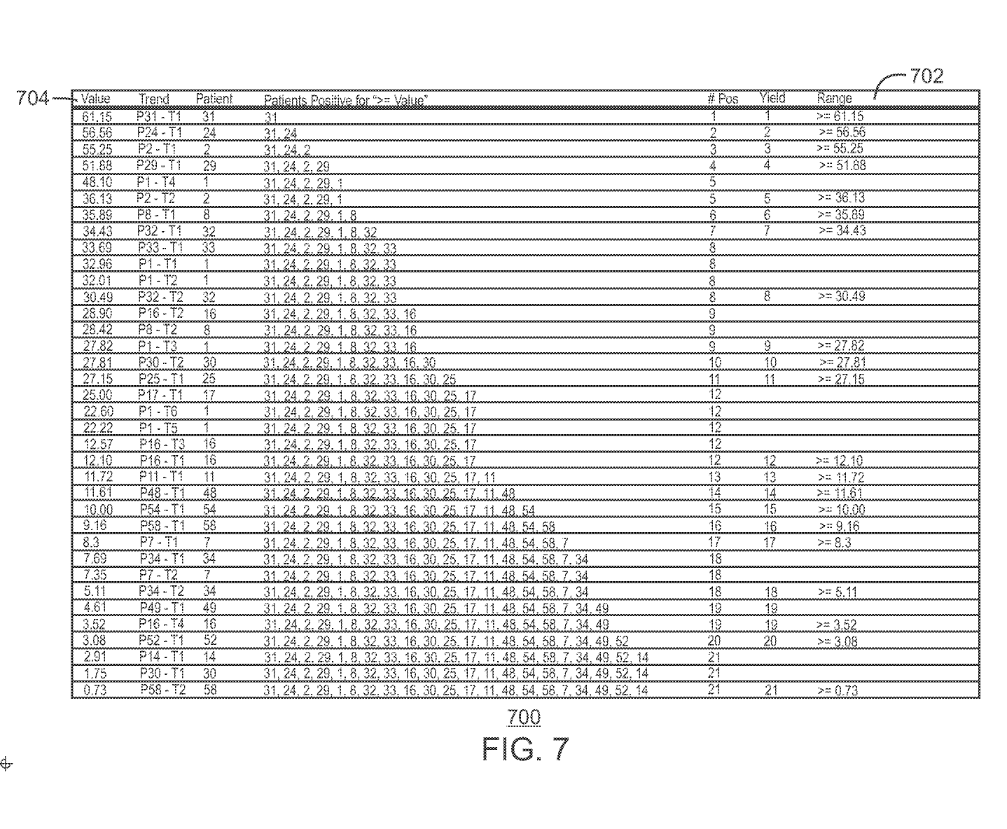

FIG. 7 depicts a table that includes a patient count. In some embodiments, the property distribution analysis process includes generating a table 700 by calculating the range of a variable “@X” 702 for each variable value 704.

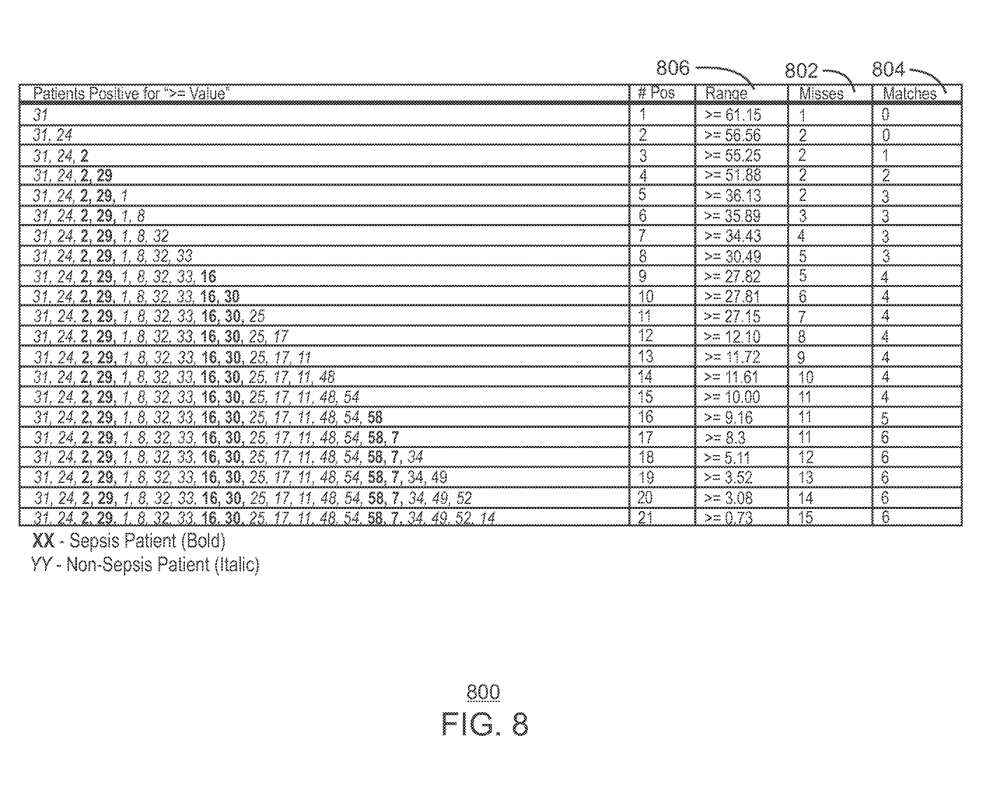

FIG. 8 depicts the elimination of the rows that make no change in the patient count. According to table 800, each patient is tagged for a physiological condition, such as a sepsis condition. In some examples, the table 800 also enables the property distribution analysis process to determine the misses 802 and matches 804 for various physiological conditions, such as sepsis. The table 800 depicts the filtering of the set, so that the patients depicted in table 800 have ranges that make a difference in the sensitivity or specificity.

In some embodiments, the table 800 depicts a complete set of values 806 for a particular variable @X that corresponds with a certain magnitude. In some examples, any suitable number of scripts can be generated from the identified values in table 800. Each identified value may have a different statistical characteristic and the possible statistical characteristics for this template/property combination are known for the given marked region universe 106.

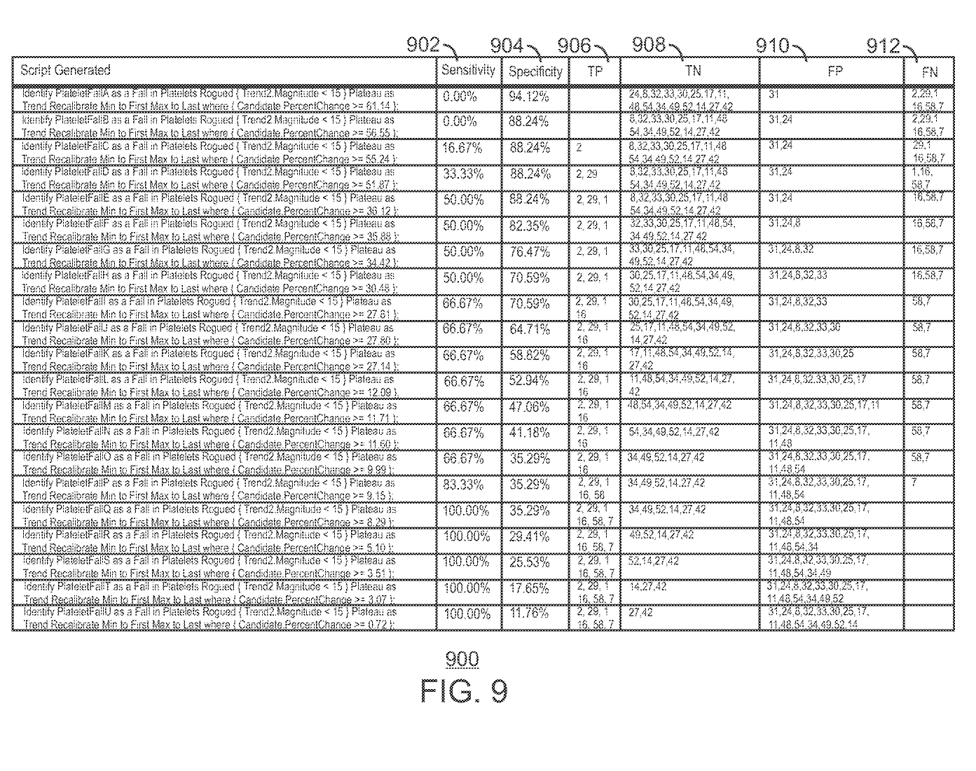

FIG. 9 depicts a table indicating the predictive characteristics for patients based on a script. In some embodiments, the property distribution analysis process can also generate a chart 900 based on the statistical characteristics for each result script without executing the PSP engine 104. In some examples, the property distribution analysis process may have access to certain data fields. For example, the property distribution analysis process may have access to a list of patients that are identified for each value. Additionally, the property distribution analysis process may have access to data related to a set of patients, such as whether each patient suffers from sepsis. In some embodiments, the property distribution analysis process can calculate sensitivity 902 and specificity 904 as well as determine the True Positive (TP) 906, True Negative (TN) 908, False Positive (FP) 910, and False Negative (FN) 912 patient sets.

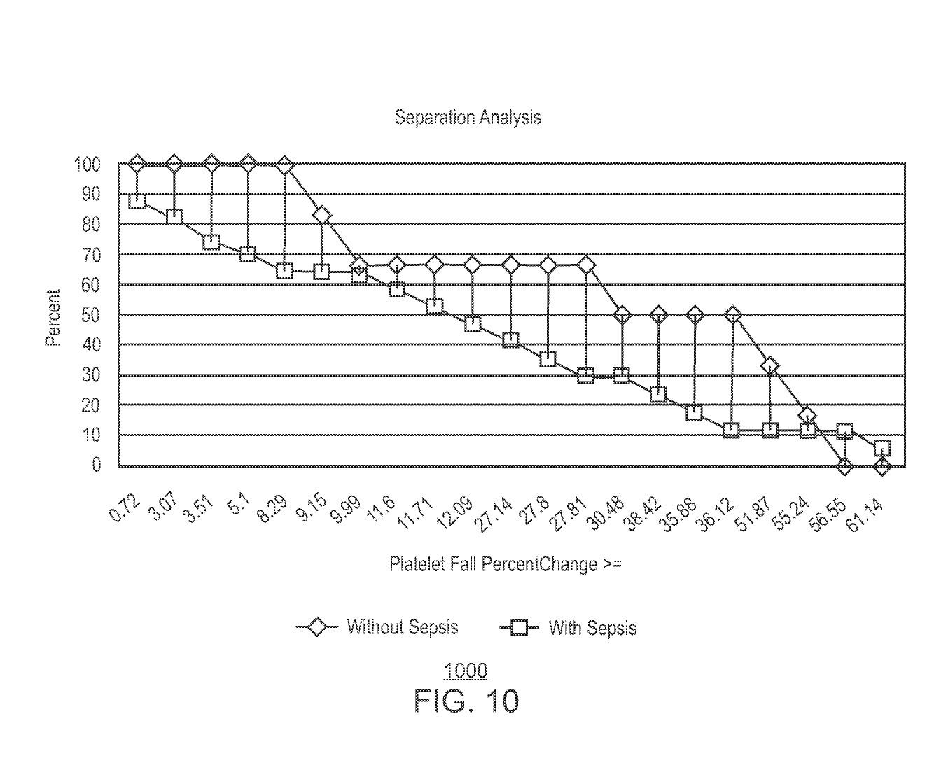

FIG. 10 shows an example of a separation analysis chart. In some embodiments, the property distribution analysis process displays a chart 1000 that can indicate if a physiological factor is correlated with a particular condition. For example, the chart 1000 illustrates that the PercentChange of PlateletFall is not well correlated to Sepsis. In some examples, the IPE engine 118 does not discard the results from a distribution even if the distribution fails to show a correlation between a physiological factor and a condition. In some embodiments, the distribution displayed in chart 1000 can still contribute to a highly predictive pattern. For example, a distribution displayed in chart 1000 may provide predictive power in a relational context.

In one embodiment one form of the seeding the field mechanism is to use the property distribution analysis process. In some examples, the property distribution analysis process may include various assumptions. For example, the property distribution analysis process may assume a marked region universe 106 exists. The property distribution analysis process may also assume a template script with a single variable for a property value exists. Additionally, the property distribution analysis process may also assume an appropriate accumulative expression (e.g. >=) is used. Based on these assumptions, the property distribution analysis process may include creating a broadly defined executable script to obtain a superset of occurrences. The property distribution analysis process may also include executing the script to obtain occurrences and creating a set that maps the region identifier with the value of the isolated property under consideration. Additionally, the property distribution analysis process may include sorting the results by the property value. Furthermore, the property distribution analysis process may include grouping the results by the property value to deal with duplicates. The property distribution analysis process may also include determining which regions are aggregated by a “>=@X” condition for each row. In addition, the property distribution analysis process may also include calculating the value range for each change in the count of regions captured. The property distribution analysis process may also include removing all rows for which there is no change in the region count. Furthermore, the property distribution analysis process may include generating scripts from the identified values and calculating the predictive characteristics.

In one embodiment, alterations and additional logic exist to direct/constrain the process. For example, very small differences in the value of a property can change the number of regions identified. These tiny changes can be known to be physiologically insignificant. Constraints can be, and in one embodiment are, added to the process to not allow these tiny differentiations. For example, the process may use a minimum percent change variable that indicates when a new script may be generated.

Seeding the field 120 can be performed with any combination of the processes described above in relation to FIGS. 1-10. For example, seeding the field 120 can incorporate scripts 102, decomposed scripts, automated scripts with sliding property values, and property distribution analysis, among others. In some embodiments, seeding the field 120 can use any number of techniques and processes to aggregate the results into a single field.

In one embodiment, once the field has been “seeded” and more than one script has been placed in the field, then the process of executing combinatorial moves can begin.

In one embodiment, during the process of seeding the field 120 another accumulation of data, the occurrence bin 116, is created as shown in FIG. 1. The occurrence bin 116 contains lightweight objects that represent occurrences found by the scripts 102 in the results field 112. The lightweight objects, for example, may contain a region identifier, a script identifier, a start time, and duration, among others. In some embodiments, the occurrence bin 116 is comprehensive (in other words, the occurrence bin 116 represents all of the occurrences for all of the scripts 102 in the results field 112 for all of the regions in the target region universe 108). Alternatively, the occurrence bin 116 can contain a subset of occurrences or the occurrence bin 116 may be created empty such that the enhancement process (shown as make moves 122 in FIG. 1) can fill the occurrence bin 116 on demand. The occurrence bin 116 is used by some types of moves for finding coincidental, time-based relationships between occurrence instances.

### Enhancement Through Combinatorial Moves

The results field 112 provides a list of scripts 102 with varying predictive characteristics with respect to a given marked region universe 106. The predictive characteristics, in one embodiment, include sensitivity, specificity and four region sets: True Positive (TP), False Positive (FP), True Negative (TN) and False Negative (FN). The scripts 102 can also contain physiological stream dependencies. Further, in some embodiments, the seeding the field process 116 creates an occurrence bin 116 of lightweight objects representing the occurrences identified for the scripts 102 in the results field 112 for the regions in the target region universe 108. As shown in FIG. 1, the lightweight objects can represent inputs into the enhancement process (shown as make moves 122) along with the input into the seeding the field process 116 including the marked region universe 106, the scripts 102, and the hints 124.

In some embodiments, the process of enhancement can be an iterative process of examining scripts 102 in the results field 112 and finding moves that will create desired affects in the predictive characteristics and/or the physiological stream dependencies. In some examples, the process of making moves simulates the process of a researcher attempting to find more predictive patterns. For example, a directional event (e.g. a fall trend) may be created that is expected to have a high correlation to sepsis. In some embodiments, the directional event may be incorporated into a PDL script and the PDL script may be executed using data related to a set of patients as input. The PDL script may produce results categorized into groups. For example, a group of patients that fall into the false negative group can represent cases in which the directional event (e.g. fall event) did not identify patients that are known to have sepsis. In some embodiments, the false negative group may be analyzed to determine how patients that have sepsis have been included in the false negative group. For example, analysis of the false negative group may determine that the fall event was too strict (e.g. that the magnitude expectation was too high) or that the fall event was not exhibited within a sub-group of sepsis patients.

Some embodiments may address when the fall event was too strict. For example, the fall event may be modified so that the fall event is broader (e.g. by lowering the magnitude expectation). As a result to broadening the fall event, the size of the false negative group may expand beyond a predetermined threshold. If the size of the false negative group grows beyond a particular threshold, a relational solution can be used. For example, by using the fall event in isolation the size of the false positive group may be large. To reduce the size of the false positive group, the fall event may be coupled with another event that correlates to sepsis. For example, the fall event may be considered over a limited time distance in conjunction with another event that is correlated to sepsis. In some examples, considering two events associated with sepsis can identify more patients with sepsis and reduce the size of the false negative group. The combination of two events associated with sepsis can be referred to as a binary move. In some embodiments, a binary move can include combining two events that have a limited correlation to sepsis within the target universe, which results in a third new pattern that has a better correlation to sepsis within the target universe.

In some embodiments, analysis may address results in which a subset of sepsis patients do not exhibit the fall event. In some examples, an alternate pattern may be generated that targets the subset of sepsis patients that did not exhibit the fall event. The alternate pattern may be combined with the fall event to create a classify move. In some embodiments, the classify move includes results from the alternate pattern or the fall event without reference to time.

The IPE engine 118 automates this approach by using searches, set manipulation and other mechanisms to identify moves that will create new scripts with useful predictive characteristics (also referred to herein as an enhanced result set), such as an enhanced sensitivity and specificity range 128. The process of creating new scripts with predictive characteristics can be automated because the results of the moves can be determined either through a mathematical function (e.g. deterministically) or through actually creating the new script and executing the PSP engine 104 to see the results (e.g. through experimentation). In some embodiments, any combination of the techniques described above can be implemented.

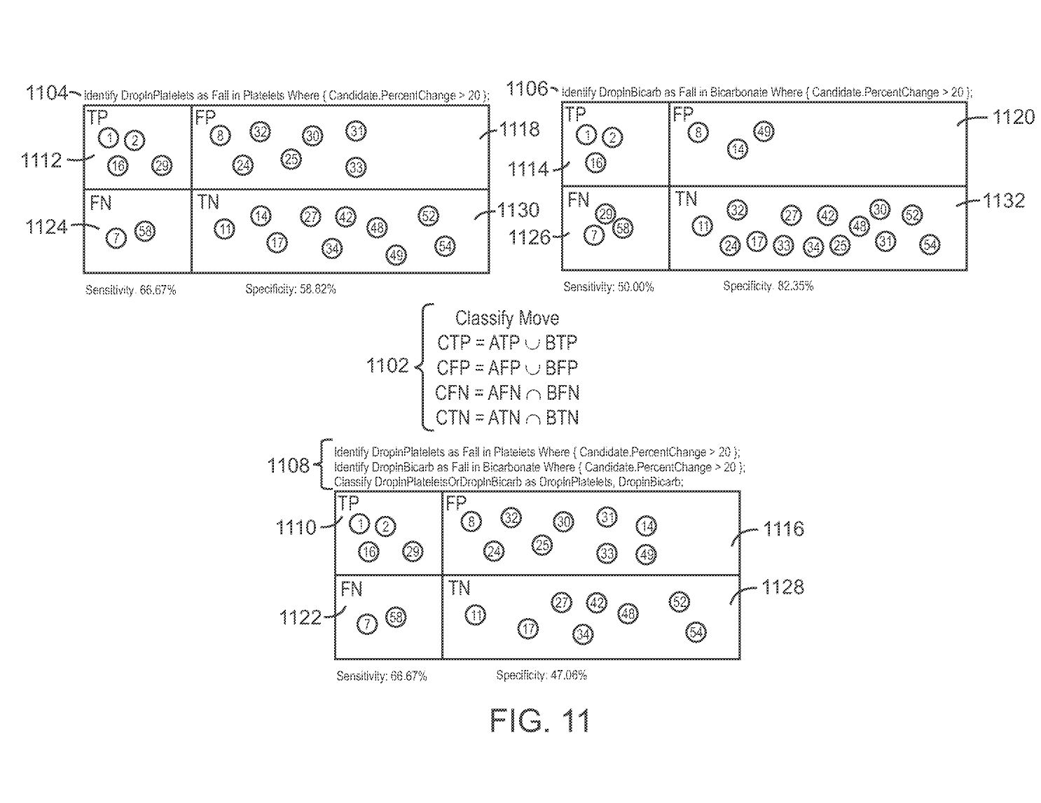

An example of a deterministic move is the classify move, which is illustrated in FIG. 11. The classify move 1102 may be applied to any suitable number of patients. For example, the 23 patients represented in FIG. 3 may be used with the classify move 1102. The classify move 1102 can calculate a result from any suitable number of scripts, such as 1104 and 1106. In some embodiments, the classify move 1102 may also consider data separated into any suitable number of groups, such as TP, FP, FN, and TN. In some examples, data can also be separated based on sensitivity and specificity values. The result of the classify move 1102 on scripts 1104 and 1106 is Script C 1108. The set equations in the middle of FIG. 11 describe the set functions that can be executed to derive the quadrant sets (the TP set, FP set, TN, set, and FN set) for the result. In some examples, the classify move 1102 may not include executing the script to determine the results since the results can be derived as a function of the results of the source scripts. As illustrated, the results can be derived using the given set equations.

In FIG. 11, the region CTP 1110 (e.g. the set of patients that make up the true positive set for Script C) can be derived by taking the union of region TP of script A results 1112 and region TP of script B results 1114. The region CFP 1116 can be derived by taking the union of AFP 1118 and BFP 1120. The region CFN 1122 can be derived by taking the intersection of AFN 1124 and BFN 1126. The region CTN 1128 can be derived by taking the intersection of ATN 1130 and BTN 1132.

In some embodiments, the IPE engine 118 can determine when to execute a classify move 1102. In some embodiments, the classify move 1102 can enhance the outcome (by increasing sensitivity) if the following conditions exist:
AFP Δ BFP=Ø (e.g. the difference between the A False Positive Set and B False Positive Set is an Empty Set)
ATP Δ BTP≠Ø (e.g. the difference between the A True Positive Set and B True Positive Set is not an Empty Set)

When both of these conditions are true then the classify move 1102 can increase sensitivity without decreasing specificity, which is also referred to as a safe move. In some embodiments, an effective move can include finding the cases in which AFP Δ BFP=Ø and then finding within that set the maximum size of ATP Δ BTP. The following formula describes the effective move:
AFP Δ BFP=Ø and |ATP Δ BTP|=maximum |ATP Δ BTP|

In some examples, if an unsafe move is allowed (e.g. if Specificity can be relaxed), then the maximum gain in sensitivity can be achieved at the minimum cost of specificity with the following:
Within the set where |AFP Δ BFP|=minimum |AFP Δ BFP|
find the set where |ATP Δ BTP|=maximum |ATP Δ BTP|

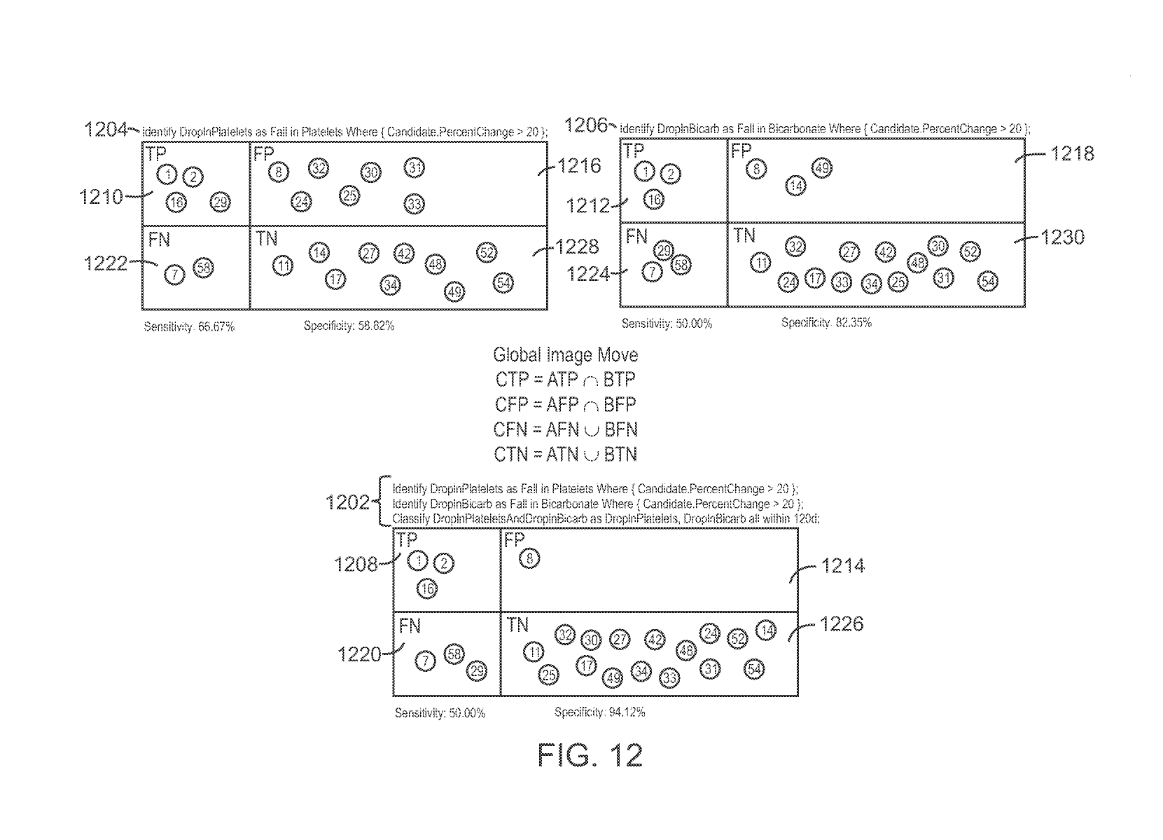

A second example of a deterministic move is the global image move. The global image move is illustrated in FIG. 12. The Script C 1202 shown is the resulting script. The set equations in the middle of FIG. 12 describe the set functions for Script C 1202 that can be executed to derive the quadrant sets for the result. In some examples, the global image move may not include executing Script C 1202 to determine the results. In these examples, the results can be derived from the results of the source scripts 1204 and 1206. As illustrated, the results can be derived using the following set equations.

The region CTP 1208 (e.g. the set of patients that make up the True Positive set for the Result Script C) can be derived by taking the intersection of 1210 ATP and 1212 BTP. The region CFP 1214 can be derived by taking the intersection of AFP 1216 and BFP 1218. The region CFN 1220 can be derived by taking the union of AFN 1222 and BFN 1224. The region CTN 1226 can be derived by taking the union of ATN 1228 and BTN 1230.

In some embodiments, the IPE engine 118 can use these equations to determine when to execute a classify move 1102. The classify move 1102 can enhance the outcome (by increasing specificity) if the following conditions exist:
AFN Δ BFN=Ø
ATN Δ BTN≠Ø

In some embodiments, a global image move can be identified by finding all cases in which AFN Δ BFN=Ø and then finding within that set the maximum size of ATN Δ BTN, as described in the following conditions:

AFN Δ BFN=Ø and |ATN Δ BTN|=maximum |ATN Δ BTN|

If an unsafe move is allowed (e.g. if sensitivity can be relaxed), then the maximum gain in specificity can be achieved at the minimum cost of sensitivity with the following:
Within the set where |AFN Δ BFN|=minimum |ATN Δ BTN|
find the set where |ATN Δ BTN|=maximum |ATN Δ BTN|

In some embodiments, classify moves 1102 and global image moves represent two deterministic moves. Another category of move is a relational move, which includes a binary move. In some examples, a binary move is constructed by combining two occurrence types into a relational binary. For example, the following scripts may be combined into a binary script.

```
identify platelet_fall as fall in Platelets where { ( candidate.Magnitude /
        candidate.FirstValue ) >= 0.2} ;
identify bicarb_fall as fall in Bicarbonate where { ( candidate.Magnitude /
        candidate.FirstValue ) >= 0.2} ;
```

These two scripts can be combined into the following binary script:

```
identify platelet_fall as fall in Platelets where { ( candidate.Magnitude /
        candidate.FirstValue ) >= 0.2} ;
identify bicarb_fall as fall in Bicarbonate where { ( candidate.Magnitude /
        candidate.FirstValue ) >= 0.2} ;
identify destabilization as platelet_fall following bicarb_fall within 1d;
```

The results of this combined Script can be determined by executing the PSP engine 104. Further, if the occurrence results of the platelet_fall and bicarb_fall scripts are in the occurrence bin 116, then the IPE engine 118 can determine the result by querying the occurrence bin 116. This is true because the relationship described in the destabilization script can be based on the coincidence in time of occurrences in the platelet_fall and bicarb_fall streams.

Many other moves are available to the IPE engine 118, such as a Time-Limited Image and a Repeating Occurrence, among others. In some embodiments, many language features in PDL and IronPython can be represented by moves in the IPE engine 118.

In some embodiments, the IPE engine 118 can incorporate the following operations:
1. Select a set of seeds from the field
2. If no seeds are in the list stop the process and report the results
3. Remove the first seed from the list of seeds and find enhanced moves that can be created using that seed
4. Validate the moves found
5. If no positive moves are found return to operation 2
6. Else Execute the moves
7. Log the moves
8. Place the results of the moves into the field
9. Determine if any of the results generated from the moves should be placed in the list of seeds and if so add them
10. Repeat starting at operation 2

The selection of the seed can be based on the desired results of the move. For example, if the goal is to maximize sensitivity, then the process may select a seed with the highest sensitivity and search for moves to increase the sensitivity. In some embodiments, other factors may apply. For example, the selection may be limited to scripts 102 with specific physiological stream dependencies.

In one embodiment, the list of seeds drives the process and when the list of seeds is empty then the process ends and the results can be reported. Since moves can create results that may be good seeds, the list of seeds is dynamic and will grow and shrink during the process.

Finding an enhanced move can be dependent on the type of moves available and the desired results. This process may use the 4 quadrant sets (TP, FP, TN, FN), as in the case of a classify move 1102 of FIG. 11, or may use the occurrence bin 116 of FIG. 1, or other data. Further, the hints 124 may constrain and/or direct this process. Hints 124 can provide a way for researcher knowledge to override, direct or constrain the search process. For example, if the Researcher is aware that the values in a particular physiological signal are relative (e.g. for a Pleth signal) then the Researcher may indicate that Threshold Events for that signal will not be useful. Further, the Researcher may indicate through hints 124 that a subset of signals are likely to be related and therefore the search process would give priority to relationships found within that subset. In this way, hints 124 can direct the process without providing hard and fast constraints. For some moves the occurrence bin 116 will also be used to find moves. For example, as described above, the Binary Move may search the occurrence bin 116 for coincidence of occurrences within the False Negative region set. In this way the IPE is searching for relationships that exist within the subset of regions that have failed to be identified. Beginning with the found instances of occurrence coincidence the IPE engine 118 can construct a script 102 (e.g. Binary, Image or Repeating Occurrence). Once a Script has been constructed then the IPE engine 118 can determine the correlation of the new relationship to the condition (e.g. Sepsis). In other words, the IPE engine 118 can search to determine if the relationship identified provides statistical separation. Since relationships often have a time dimension, the IPE engine 118 may choose to use a process similar to that described in the Seeding the Field 120 section above to create a set of times. For example, the IPE engine 118 may use property analysis distribution against the time distance between the start times of two Directional Events.

In one embodiment, once a set of positive moves have been found then those moves are validated. Validation may include pruning moves that represent equivalent paths or may be directed and/or constrained by hints 124. Validation can includes more “costly” processing than the filters used within the “Find Enhanced Moves” operation or involves looking at the set of moves found as a whole.

Once valid moves have been selected, the process can determine if any good moves have been found. If no good moves have been found, the process starts a new iteration with the next seed in the list. If valid moves are found, then the valid moves are executed and log records are generated and placed into the enhancement log 126 of FIG. 1. The enhancement log 126 provides visibility into the process for a user. When results out of the process do not meet certain criteria, the process can incorporate additional input, such as hints 124, among others. In one embodiment, the execution of a move can involve any suitable combination of three operations: the creation of the new script, the acquisition of the statistical characteristics (e.g. sensitivity, specificity, quadrant sets) and the generation of lightweight occurrences into the occurrence bin 116.

Once moves have been executed, the results are placed into the results field 112 and optionally the occurrence bin 116 of FIG. 1. In some embodiments, scripts 102 that are created can represent good seeds. If the scripts 102 represent good seeds, then the seeds are placed into the list of seeds to be explored. In a sense, the seed list represents a list of paths that the IPE engine 118 can explore as the IPE engine 118 attempts to generate desirable results.

At this point in the process, the IPE engine 118 can determine whether any seeds still exist in the seed list. If seeds still exist in the seed list, then a new iteration is executed at operation 2.

If no seeds exist in the seed list, then the process ends and the results are presented. In one embodiment, the results consist of a set of enhanced scripts 114 and the enhancement log 126 of FIG. 1. The statistical characteristics of the enhanced scripts 114 may be presented in chart form or some form that displays the progress made.

Alternatively, the entire result field 110 and the occurrence bin 116 can be outputted for examination by a researcher, persisted and/or transmitted as input into another software component.

### IPE Validation

In some situations, scripts 102 may be considered and/or created that are based on statistical anomalies rather than true physiological phenomenon. One embodiment of the IPE engine 118 provides a plurality of exemplary mechanisms which may be used alone or in combination to identify and eliminate these cases.

In one example, the process avoids approaches that would engage or aggregate anomalies. For example, the use of the “>=” operator in the property distribution analysis process rather than the “=” operator or a range (e.g. both “>=” and “<=”) can help to avoid fine tuning.

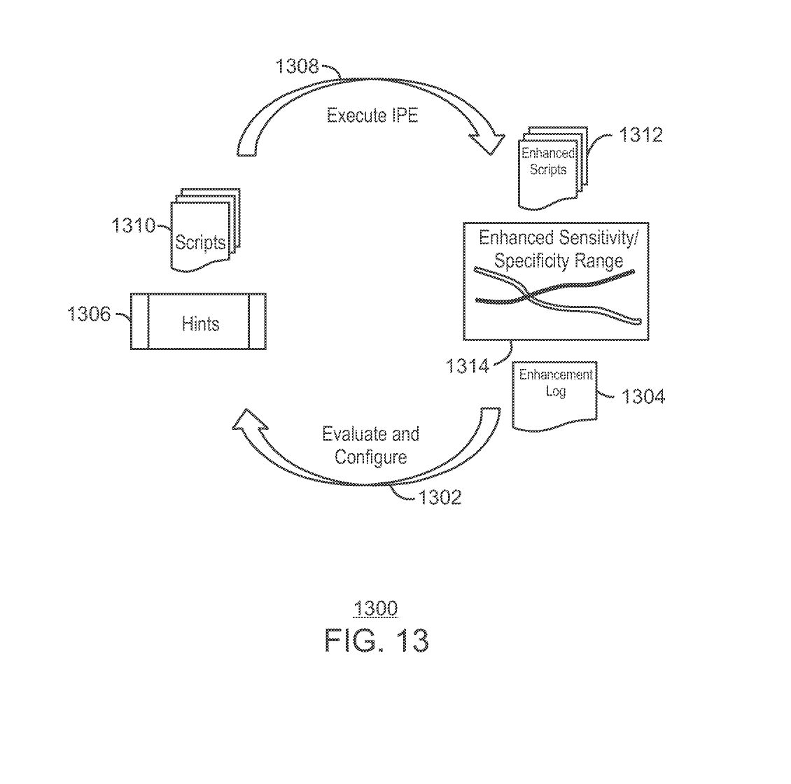

In another example, the feedback mechanism (also referred to herein as evaluate and configure) 1302 supplied through the enhancement log 1304 of FIG. 13 and the hints 1306 of FIG. 13 provides the ability to iteratively execute the IPE engine 1308 and remove results that are identified as being anomalous based on their understanding of human physiology and the relationships among physiological signals.

As well, the IPE engine 1308 may provide the ability to execute the results against subsequent marked region universes 106 of FIG. 1 to understand and explore the predictive capability of the generated scripts within an unknown set. In one embodiment the IPE engine 1308 can look for variability within the predictive characteristics (e.g. sensitivity and specificity) and present them to a researcher in a way that informs the feedback cycle 1302 of FIG. 13. For example, the IPE engine 1308 may include executing scripts 1310 and comparing the results of the scripts 1310 with a subsequent marked region universe 106 to generate enhanced scripts 1312. The IPE engine 1308 may also include reporting enhanced scripts 1312 for which the sensitivity and specificity range 1314 were enhanced from the original set. In some embodiments, a researcher can examine the internals of the script 1310 to determine what elements are anomalous and use hints 1306 to direct the next run to exclude those paths.

In one embodiment, the IPE engine 1308 is utilized to identify scripts 1310 to support a visualization that includes a plane representing a fixed set of physiological sub-systems as large rows or ranks. On top of this background individual pixels (or small shapes) are placed to indicate the existence of a pattern. In one embodiment each pixel in the plane is a separate pattern. In an alternative embodiment, a pattern (or set of patterns) is represented by a single row of pixels on the plane and the x-axis of the plane represents time. In this way, the evolution of a condition over time can be visualized in a single image. Alternatively, substantially all pixels on the plane represent a pattern or set of patterns and animation is used to demonstrate the evolution of a condition over time. Each pixel in this visualization can further be differentiated by color. Additionally, iconic or textual elements may be overlaid to further communicate features of the condition or the evolution of the condition. The color displayed for each pixel can be chosen by the count of instances of the patterns represented, severity, correlativity metrics of the pattern, or features of the pattern to name a few. In an alternative embodiment, the field represents the one portion of the visualization and a pattern catalog represents another area in the a way that the selection of pixels can drive the display of individual patterns (in textual, parametric or diagrammatic form) or the selections of patterns and/or their individual elements can indicate which pixel or pixel row is associated. The IPE process 1308 and user interface may be used to support this visualization by providing aid in creating and identifying patterns, ordering or placing those patterns into a layout for the plane, and/or otherwise categorizing patterns.

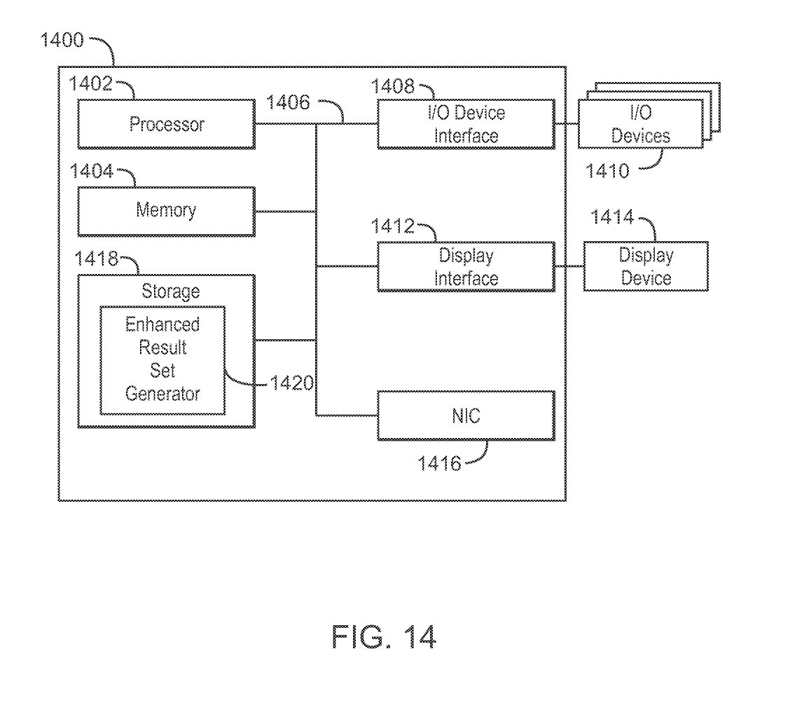

FIG. 14 is a block diagram of an example of a computing system that can generate an enhanced result set. The computing system 1400 may be, for example, a mobile phone, laptop computer, desktop computer, or tablet computer, among others. The computing system 1400 may include a processor 1402 that is adapted to execute stored instructions, as well as a memory device 1404 that stores instructions that are executable by the processor 1402. The processor 1402 can be a single core processor, a multi-core processor, a computing cluster, or any number of other configurations. The memory device 1404 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The instructions that are executed by the processor 1402 may be used to implement a method that includes generating an enhanced result set.

The processor 1402 may be connected through a system interconnect 1406 (e.g., PCI, ISA, PCI-Express, HyperTransport®, NuBus, etc.) to an input/output (I/O) device interface 1408 adapted to connect the computing system 1400 to one or more I/O devices 1410. The I/O devices 1410 may include, for example, a keyboard and a pointing device, wherein the pointing device may include a touchpad or a touchscreen, among others. The I/O devices 1410 may be built-in components of the computing system 1400, or may be devices that are externally connected to the computing system 1400.

The processor 1402 may also be linked through the system interconnect 1406 to a display interface 1412 adapted to connect the computing system 1400 to a display device 1414. The display device 1414 may include a display screen that is a built-in component of the computing system 1400. The display device 1414 may also include a computer monitor, television, or projector, among others, that is externally connected to the computing system 1400. In addition, a network interface card (NIC) 1416 may be adapted to connect the computing system 1400 through the system interconnect 1406 to a network (not depicted). The network (not depicted) may be a wide area network (WAN), local area network (LAN), or the Internet, among others.

The storage device 1418 can include a hard drive, an optical drive, a USB flash drive, an array of drives, or any combinations thereof. The storage device 1418 may include an enhanced result set generator 1420 that can generate an enhanced result set by generating an enhanced script using a first script and a set of data, such as the marked region universe 106.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional memory components, additional modules, additional network interfaces, etc.). Furthermore, any of the functionalities of the code generator 120 may be partially, or entirely, implemented in hardware and/or in the processor 102. For example, the functionality may be implemented with an application specific integrated circuit, or in logic implemented in the processor 102, among others.

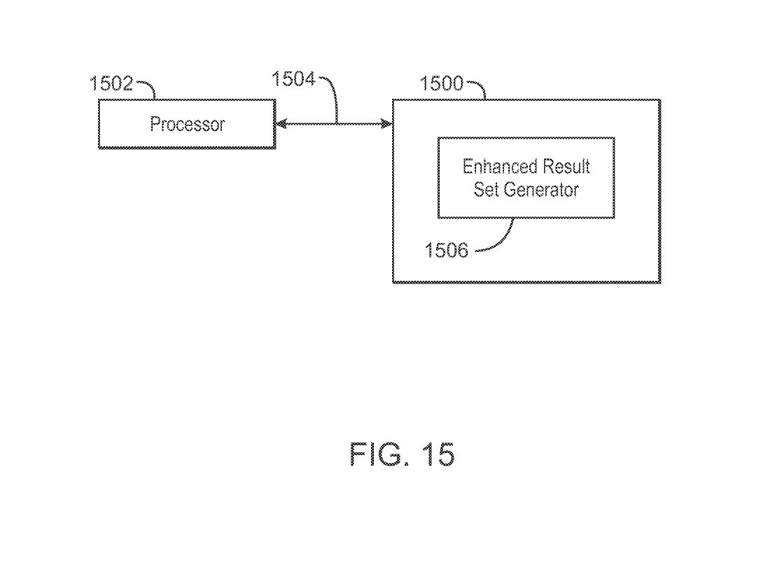

FIG. 15 is a tangible, non-transitory computer-readable media that can enable a computing system to generate an enhanced result set. The tangible, non-transitory, computer-readable medium 1500 may be accessed by a processor 1502 over a computer interconnect 1504. Furthermore, the tangible, non-transitory, computer-readable medium 1500 may include code to direct the processor 1502 to perform the steps of the current method.

The various software components discussed herein may be stored on the tangible, non-transitory, computer-readable medium 1500, as indicated in FIG. 15. For example, an enhanced result set generator 1506 may be adapted to direct the processor 1502 to generate an enhanced result set based on a first script and a set of data, such as the marked region universe 106. It is to be understood that any number of additional software components not shown in FIG. 15 may be included within the tangible, non-transitory, computer-readable medium 1500, depending on the specific application.

Conditional language used herein, such as, among others, “can,” “may,” “might,” “could,” “e.g.,” and the like, unless specifically stated otherwise, or otherwise understood within the context as used, is generally intended to convey that certain embodiments include, while other embodiments do not include, certain features, elements and/or operations. Thus, such conditional language is not generally intended to imply that features, elements and/or operations are in any way required for one or more embodiments or that one or more embodiments necessarily include logic for deciding, with or without author input or prompting, whether these features, elements and/or operations are included or are to be performed in any particular embodiment.

While the above detailed description has shown, described, and pointed out features as applied to various embodiments, it will be understood that various omissions, substitutions, and changes in the form and details of the device or process illustrated can be made without departing from the spirit of the disclosure. As will be recognized, certain embodiments of the techniques described herein can be embodied within a form that does not provide all of the features and benefits set forth herein, as some features can be used or practiced separately from others. The scope of the techniques is indicated by the appended claims rather than by the foregoing description. All changes which come within the meaning and range of equivalency of the claims are to be embraced within their scope.

What is claimed is:

1. A method for analyzing data about a dynamic time dimensioned pathophysiological occurrence, comprising:
executing a first software element to produce a result set with time series matrix data of at least measured laboratory and vitals values related to a set of patients;
detecting or failing to detect a dynamic time dimensioned pathophysiological occurrence within the result set; and
generating a second software element to enhance the first software element based on the pathophysiological occurrence and the time series matrix data from the set of patients by combining patterns along one time series with time series patterns along a plurality of other time series to generate new and more complex time dimensioned patterns with enhanced sensitivity, specificity, correlation, or reduced diagnostic delay for the pathophysiologic occurrence.

2. The method recited in claim 1, comprising:
executing the second software element to generate an enhanced result set; and
displaying the enhanced result set.

3. The method recited in claim 1, wherein the first software element comprises a script.

4. The method recited in claim 1, wherein the second software element comprises a script.

5. The method of claim 2, wherein the enhanced result set comprises an enhanced sensitivity range and an enhanced specificity range.

6. The method of claim 1, wherein executing the first software element to produce a result set with the physiological data from related to the set of patients comprises generating a series of software elements based on a range of variable values for the first script.

7. The method of claim 6, wherein the range of variable values is determined based on hints.

8. The method of claim 1 wherein a physiological occurrence is sepsis.

9. The method of claim 1, wherein the result set comprises at least one of a sensitivity value, a specificity value, a correlation value, or a diagnostic delay value.

10. The method of claim 1, further comprising receiving proposed patterns inputted by a user and comparing at least one proposed pattern against processor-generated patterns to identify if the proposed pattern provides greater sensitivity or specificity than processor-generated patterns for showing sensitivity, specificity, correlation, or reduced diagnostic delay for a distress condition.

11. The method of claim 1, wherein generating a second software element comprises using a classify move to combine two existing software elements to generate a higher sensitivity value.

12. The method of claim 1, wherein generating a second software element comprises using a global image move to combine two existing software elements to generate a higher specificity value.

13. The method of claim 1, wherein the result set comprises four sets of values that represent a true positive set, a true negative set, a false positive set, and a false negative set.

14. The method of claim 1, wherein the enhanced result set comprises a set of patients, wherein each patient suffers from the physiological occurrence.

15. A system for identifying a physiological occurrence comprising:
a processor to execute computer-readable instructions; and
a storage device to store the computer-readable instructions, the computer-readable instructions to direct the processor to:
execute a first software element to produce a result set with time series matrix physiological data of at least measured laboratory and vitals values related to a set of patients;
detect or fail to detect a dynamic time dimensioned pathophysiological occurrence within the result set;
generate a second software element to enhance first software element based on the physiological occurrence and the pathophysiological data from the set of patients by combining patterns along one time series with time series patterns along a plurality of other time series to generate new and more complex time dimensioned patterns with enhanced sensitivity, specificity, correlation, or reduced diagnostic delay for the pathophysiologic occurrence; and
execute the second software element to generate an enhanced result set; and
display the enhanced result set.

16. The system of claim 15, wherein the first software element comprises a script.

17. The system of claim 15, wherein the second software element comprises a script.

18. The system of claim 15, wherein the enhanced result set comprises an enhanced sensitivity range and an enhanced specificity range.

19. The system of claim 15, wherein the computer-readable instructions direct the processor to generate a series of software elements based on a range of variable values for the first script.

20. The system of claim 19, wherein the range of variable values is determined based on hints.

21. The system of claim 15 wherein a physiological occurrence is sepsis.

22. The system of claim 15, wherein the result set comprises at least one of a sensitivity value, a specificity value, a correlation value, or a diagnostic delay value.

23. The system of claim 15, wherein computer-readable instructions direct the processor to receive proposed patterns inputted by a user and compare at least one proposed pattern against processor-generated patterns to identify if the proposed pattern provides greater sensitivity or specificity than processor-generated patterns for showing sensitivity, specificity, correlation, or reduced diagnostic delay for the pathophysiologic occurrence.

24. The system of claim 15, wherein the computer-readable instructions direct the processor to use a classify move to combine two existing software elements to generate a higher sensitivity or specificity value.

25. The system of claim 15, wherein the computer-readable instructions direct the processor to use a global image move to combine two existing software elements to generate a higher specificity or specificity value.

26. The system of claim 15, wherein the result set comprises four sets of values that represent a true positive set, a true negative set, a false positive set, and a false negative set.

27. The system of claim 15, wherein the enhanced result set comprises a set of patients, wherein each patient suffers from the physiological occurrence.

28. At least one non-transitory machine readable medium comprising a plurality of instructions that, in response to being executed on a computing device, cause the computing device to:
execute a first software element to produce a result set with time series physiological data of at least measured laboratory and vitals values related to a set of patients;
detect or fail to detect a dynamic time dimensioned pathophysiological occurrence within the result set; and
generate a second software element to enhance the first software element based on the physiological occurrence and the pathophysiological data from the set of patients by combining patterns along one time series with time series patterns along a plurality of other time series to generate new and more complex time dimensioned patterns with enhanced sensitivity, specificity, correlation, or reduced diagnostic delay for the pathophysiologic occurrence.

29. The non-transitory machine readable medium of claim 28, wherein the machine-readable instructions cause the processor to:
execute the second software element to generate an enhanced result set; and
display the enhanced result set.

30. The non-transitory machine readable medium of claim 28, wherein the first software element comprises a script.

31. The non-transitory machine readable medium of claim 28, wherein the second software element comprises a script.

32. The non-transitory machine readable medium of claim 28, wherein the enhanced result set comprises an enhanced sensitivity range and an enhanced specificity range.

33. The non-transitory machine readable medium of claim 28, wherein the machine-readable instructions cause the processor to generate a series of software elements based on a range of variable values for the first script.

34. The non-transitory machine readable medium of claim 33, wherein the range of variable values is determined based on hints.

35. The non-transitory machine readable medium of claim 28, wherein a physiological occurrence is sepsis.

36. The non-transitory machine readable medium of claim 28, wherein the result set comprises at least one of a sensitivity value, a specificity value, a correlation value, or a diagnostic delay value.

37. The non-transitory machine readable medium of claim 28, wherein the machine readable instructions cause the processor to receive proposed patterns inputted by a user and compare at least one proposed pattern against processor-generated patterns to identify if the proposed pattern provides greater sensitivity or specificity than processor-generated patterns for showing sensitivity, specificity, correlation, or reduced diagnostic delay for the pathophysiologic occurrence.

38. The non-transitory machine readable medium of claim 28, wherein the machine-readable instructions cause the processor to use a classify move to combine two existing software elements to generate a higher sensitivity value.

39. The non-transitory machine readable medium of claim 28, wherein the machine-readable instructions cause the processor to use a global image move to combine two existing software elements to generate a higher specificity value.

40. The non-transitory machine readable medium of claim 28, wherein the result set comprises four sets of values that represent a true positive set, a true negative set, a false positive set, and a false negative set.

41. The non-transitory machine readable medium of claim 28, wherein the enhanced result set comprises a set of patients, wherein each patient suffers from the physiological occurrence.

42. The method recited in claim 1, comprising converting the time series matrix data into a time series matrix of objectified data.

43. The method recited in claim 1, comprising limiting the generation and composition of new patterns according to physiological constraints.

44. The method recited in claim 1, comprising:
reverse-engineering a proposed pattern to generate related patterns for the purpose of determining whether the proposed pattern provides greater sensitivity, specify, correlation, or less diagnostic delay for the pathophysiologic occurrence than processor-generated patterns.

45. The method recited in claim 1, comprising informing a user inputting physiological patterns by providing immediate feedback of characteristics of the patterns or partial patterns being inputted and by providing suggestions that direct the user toward patterns with desired sensitivity, specificity, correlations, or reduced diagnostic delay to the pathophysiologic occurrence.
